(19) United States
(12) Patent Application Publication
(10) Pub. No.: US 2016/0140523 A1
(43) Pub. Date: May 19, 2016

(54) POSITION ADAPTIVE ATM FOR CUSTOMER PRIVACY

(71) Applicant: BANK OF AMERICA CORPORATION, Charlotte, NC (US)

(72) Inventors: Tyler Johnson, Tega Cay, SC (US); Nathan Dent, Concord, NC (US); Kristy M. Crist, Charlotte, NC (US); Christian Michael Mande, Charlotte, NC (US); James Robert Grimsley, Dover, FL (US); Sara Gill, New York, NY (US)

(21) Appl. No.: 14/540,902

(22) Filed: Nov. 13, 2014

(51) Int. Cl. G06Q 20/10

(52) U.S. Cl. CPC G06Q 20/1085

(57) ABSTRACT

Embodiments of the invention are directed to a system, method, or computer program product for providing a position adaptive Automated Teller Machine (ATM) for customer privacy. In this way, the system senses, via a sensor, characteristics associated with the customer's portion relative to the ATM screen. The characteristics may include the stature of the customer, the relative proximity the customer is to the ATM, eye tracking or the like. Once the characteristics associated with the customer are determined the system may make adjustments via software and/or hardware to the ATM in order to present display information from the ATM in a private manner.

### BACKGROUND

The advent of the Automated Teller Machine (ATM) has provided customers with convenient access to perform banking operations report of the financial institutions. This includes deposits, cash withdraws, and other transactions, such as receiving stamps, or the like. Typically, ATM machines are located on busy street corners, drive-up windows and in other public locations.

As such, a customer may input a personal identification number (PIN) and finish a banking operation while in public. Thus, there may be potential privacy concerns with respect to performing bank operations while in a public area.

### BRIEF SUMMARY

Embodiments of the present invention address the above needs and/or achieve other advantages by providing apparatuses (e.g., a system, computer program product and/or other devices) and methods for a position adaptive Automated Teller Machine (ATM) to provide a customer privacy at the ATM.

In this way, in some embodiments, the invention identifies a customer approaching an ATM. The ATM may provide ATM functionality, such as financial institution transaction capabilities and other capabilities, such as purchasing stamps or the like. The financial transaction capabilities may include, but are not limited to withdraws, deposits, money transfers, payments, acceptance of payments, and/or the like.

Upon identifying that the user approached the ATM, the system may sense the characteristics of the customer, via one or more sensing devices. The characteristics of the customer that may be sensed by the sensing devices include one or more of an identification of the customer's location relative to the ATM, the customer's stature, the time of the transaction, and eye tracking of the customer's eyes prior to the transaction. Subsequently, the system may retrieve customer sensor data from the sensors associated with the characteristics of the customer that have been identified.

The sensor data may be compiled together from the various sensors and/or customer characteristics that have been identified. The compiled data may be utilized by the system to determine an appropriate ATM display position. The appropriate ATM display position may be determined by a combination of one or more of the customer characteristics identified by the sensors. Based on the customer characteristics, the system may be able to identify the best location for the ATM to present financial information for the customer, such that the customer's privacy is protected. Thus, the system may adjust, both mechanically and/or via software, the ATM display such that it is visible to the customer and concealed or close there to from the public.

In some embodiments, the ATM display may be adjusted mechanically. In this way, the system may mechanically move the ATM display horizontally, vertically, or on one or more angles. The display may be mechanically moved using a track system, ball-and-socket, system or other means to move a display.

In some embodiments, software may be provided to adjust the position of presentation of data on the ATM display. In this way, the ATM display may have the ATM information positioned on the display in different locations. As such, the ATM information may adjusted on the display and be presented in various locations on the display, various sizes on the display, and various brightness level on the display, such that the system may provide the customer with privacy based on the presentation of the ATM information on the ATM display.

In some embodiments, the system may adjust the display mechanically. In other embodiments, the system may adjust position the ATM information on the ATM display via software. In yet other embodiments, a combination of mechanically and software adjustments may be made for customer privacy.

Finally, ones the adjustments have been decided, the system may implement the adjustments and present the ATM information to the customer such that the customer may complete his/her ATM transaction.

Embodiments of the invention relate to systems, methods, and computer program products for a position adaptive ATM, the invention comprising: identifying a customer initiating a transaction at the ATM; sensing, via sensors associated with the ATM, an environment surrounding the ATM and customer characteristics associated with the customer initiating the transaction at the ATM; determining, based on the customer characteristics and environmental surroundings, an appropriate location on the ATM for an ATM display to present information to the customer to complete an ATM transaction, wherein the appropriate location is determined to provide privacy to the customer and prevent other individuals from viewing the ATM display; determining, based on the customer characteristics and environmental surroundings, an appropriate location on the ATM display for presentation of information to the customer to complete an ATM transaction, wherein the appropriate location is determined to provide privacy to the customer and prevent other individuals from viewing the ATM display; adjusting, mechanically, a location of the ATM display to the appropriate location based on the determined appropriate location on the ATM for the ATM display; adjusting a location of the presentation of information to the customer to the appropriate location based on the determined appropriate location on the ATM display for presentation of information to the customer to complete an ATM transaction; and presenting the ATM display with the presentation of information for the customer to complete the ATM transaction.

In some embodiments, the invention further comprising tracking the eyes of the customer using the sensors, wherein when the sensors identify the customer's eyes no longer focused on the ATM, the ATM display is dimmed.

In some embodiments, mechanically adjusting the location of the ATM display comprises moving the ATM display on a track system to one or more locations on the ATM. In other embodiments, mechanically adjusting the location of the ATM display further comprises tilting the ATM display on the ATM.

In some embodiments, adjusting the location of the presentation of information comprises moving the information to one or more locations on the ATM display. In some embodiments, adjusting the location of the presentation of information further comprises adjusting the brightness level of the presentation of information on the ATM display.

In some embodiments, the invention further comprises determining a comfortable viewing location of the ATM display for the customer based on customer characteristics sensed and adjusting the ATM display to the comfortable viewing location, wherein the comfortable viewing location is determined to provide privacy to the customer and prevent other individuals from viewing the ATM display.

In some embodiments, the sensors associated with the ATM identify the environmental surroundings of the ATM including a time of day, shadowing, temperature, precipitation conditions, and population surrounding the ATM. In other embodiments, the sensors associated with the ATM identify the customer characteristics including the horizontal/vertical location of the customer, the distance the customer is from the ATM, the body position of the customer, and the stature of the customer relative to the ATM.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating the position adaptive ATM application process, in accordance with one embodiment of the present invention;

FIG. 2 provides a position adaptive ATM system environment, in accordance with one embodiment of the present invention;

FIG. 3 provides a process map illustrating sensing of customer positioning, in accordance with one embodiment of the present invention;

FIG. 4 provides a process map illustrating determining a positioning of ATM data for an ATM transaction, in accordance with one embodiment of the present invention;

FIG. 5 provides a process map illustrating mechanical and software adjustment of the ATM display and ATM information presented on the display, in accordance with one embodiment of the present invention;

FIG. 6 provides a representative illustration of a ATM, in accordance with one embodiment of the present invention;

FIG. 7 provides a process map illustrating software adjustment of the ATM information on the ATM display, in accordance with one embodiment of the present invention; and

FIG. 8 provides a process map illustrating mechanical adjustment of ATM display on the ATM, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer Automated Teller Machines (ATM).

Some portions of this disclosure are written in terms of a financial institution's unique position with respect to customer transactions. As such, a financial institution may be able to utilize its unique position to create and update ATM transactions with a customer.

The embodiments described herein may refer to the initiation of a transaction, transaction event initiated, or ATM event at to trigger the steps, functions, routines, or the like described herein. In various embodiments, occurrence of a transaction triggers the sending of information such as authentication information or the like via an ATM to initiate an ATM transaction. Unless specifically limited by the context, a “transaction”, “transaction event” or “point of transaction event” refers to any customer interaction with an ATM. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a customer interaction with an ATM, such as an account balance inquiry, a payment, a purchase, a withdraw, a rewards transfer, an account money transfer, an opening of a bank account, and/or the like.

In some embodiments, an ATM is or includes an interactive computer terminal that is configured to initiate, perform, complete, and/or facilitate one or more transactions. An ATM could be or include any device that a customer may use to perform a transaction with an entity.

In some embodiments, an ATM is operated in a public place (e.g., on a street corner, at the doorstep of a private residence, in an open market, at a public rest stop, or the like). In other embodiments, the ATM is additionally or alternatively operated in a place of business (e.g., in a retail store, post office, banking center, grocery store, factory floor, or the like). In accordance with some embodiments, the ATM is owned by the financial institution providing the ATM. In other embodiments, the ATM is owned by one or more third party merchants. In yet other embodiments, the ATM is owned by other financial institutions. While multiple ATM machines are mentioned throughout this discloser, one of ordinary skill in the art will appreciate that one ATM may include all of the features disclosed herein.

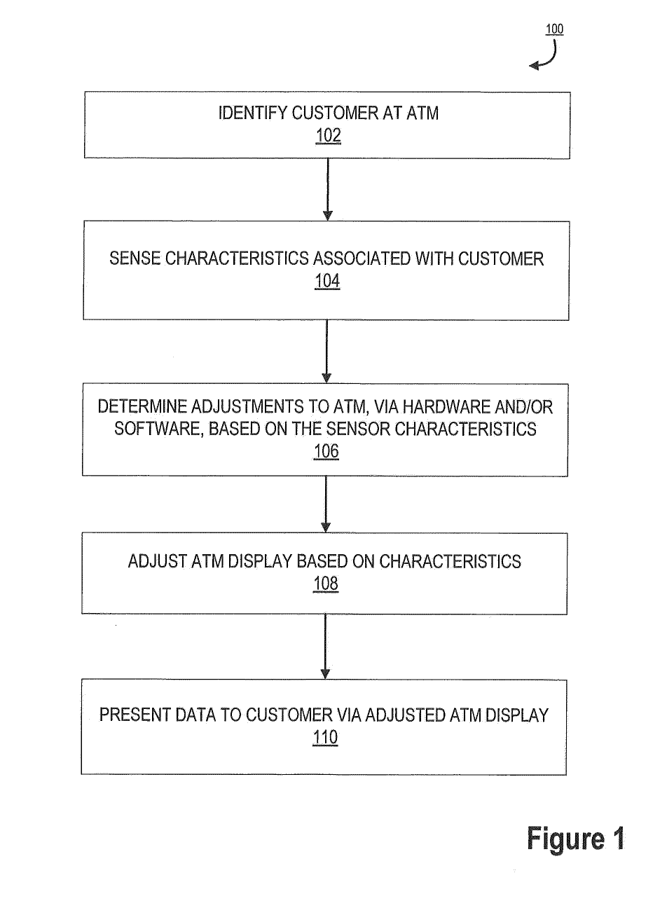

FIG. 1 provides a high level process flow illustrating position adaptive ATM application process 100, in accordance with one embodiment of the present invention. First, as illustrated in block 102, the system may identify a customer approaching or at an ATM. In some embodiments, a sensor from the system may identify a customer approaching the ATM. In other embodiments, the system may identify that a customer is at an ATM by the customer initiating a transaction with the ATM, such as initially inserting his/her debit or ATM card into the ATM.

Next, as illustrated in block 104, the process 100 continues by sensing characteristics associated with the customer. In some embodiments, the characteristics may be customer specific, such as a distance from the ATM the customer is standing, the customer's stature, eye location, eye movement, horizontal positioning relative to the ATM, and/or the like. In other embodiments, the characteristics may be environmental, such as the time of day, shadowing, temperature, precipitation conditions, or the like. In some embodiments, the characteristics are sensed by one or more sensors associated with the ATM.

Once characteristics have been identified, the system may determine adjustments to the ATM, via hardware and/or software means, based on the customer sensor data, as illustrated in block 106. In this way, the system may determine an appropriate adjustment to the ATM display in order to provide the customer with privacy during his/her ATM transaction.

Next, the system may adjust the ATM display based on the characteristics and adjustments determined therefrom, as illustrated in block 108. The adjustments may be hardware and/or software based. Hardware adjustments may include a physical moving of the display screen of the ATM which presents ATM transaction data to the customer. In other embodiments, other devices associated with the ATM may be mechanically adjusted to provide further privacy, these may include adjustments to the number pad, deposit entry ports, withdraw exit ports, PIN pads, debit/ATM card acceptors, and/or the like. Software adjustments may include moving the ATM transaction data presented to the customer to one or more different sections of the ATM display. In this way, the presented data may not take up the entire display screen, but instead be positioned in one of several different sections of the ATM display. Furthermore, software adjustments may also include presenting information on the ATM display with varying brightness levels.

Finally, once the ATM display and information on the display has been adjusted accordingly in block 108, such that the customer's privacy is fully considered, the system presents ATM transaction data to the customer via the adjusted ATM display, such that the customer may complete his/her ATM transaction, as illustrated in block 110.

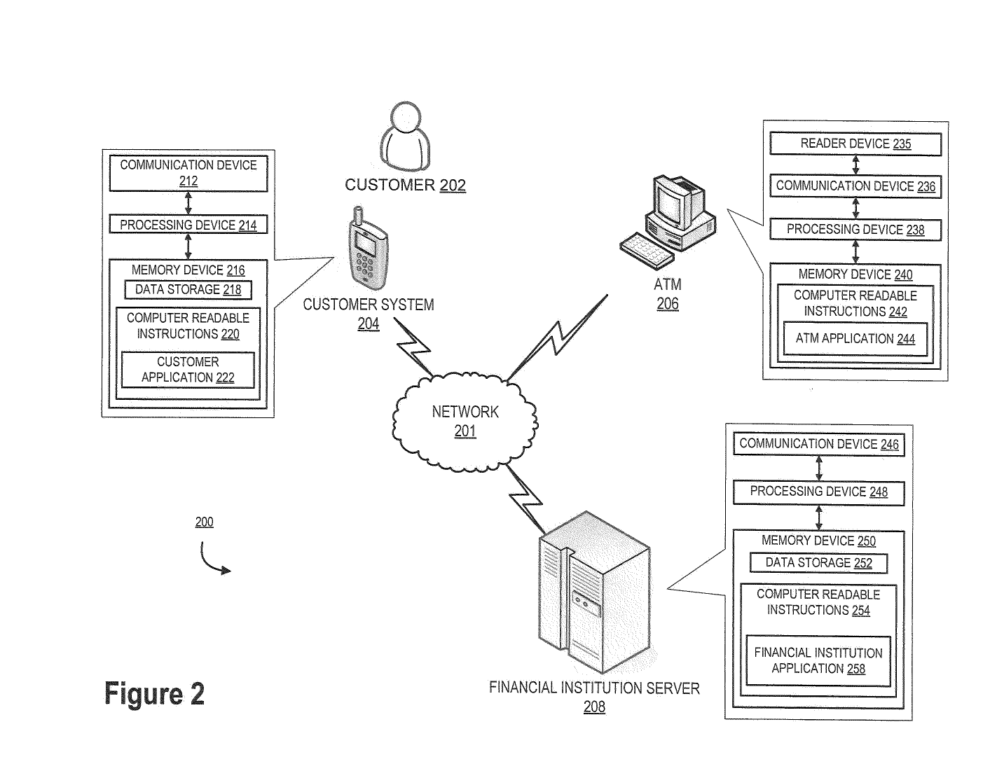

FIG. 2 illustrates a position adaptive ATM system environment 200, in accordance with one embodiment of the present invention. As illustrated in FIG. 2, the financial institution server 208 is operatively coupled, via a network 201 to the customer system 204, and to the ATM 206. In this way, the financial institution server 208 can send information to and receive information from the customer system 204 and the ATM 206 to provide a position adaptive ATM display for customer privacy. FIG. 2 illustrates only one example of an embodiment of a position adaptive ATM system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual interacting with an ATM 206 or financial institution. As such, the interaction may be made at or through an ATM 206 associated with the financial institution.

In some embodiments, the interaction may be made by the customer 202 using a customer system 204 in connection with the ATM 206 and/or the ATM 206 itself. In some embodiments, the customer 202 may be a merchant or a person, employee, agent, associate, independent contractor, and the like that has an account or business with a financial institution or another financial institution that may provide authorization for completing a transaction using the ATM 206.

FIG. 2 also illustrates a customer system 204. The customer system 204 generally comprises a communication device 212, a processing device 214, and a memory device 216. The customer system 204 is a computing system that allows a customer 202 to interact with the financial institution to set up accounts for an ATM transaction or interact with an ATM to complete an ATM transaction. The processing device 214 is operatively coupled to the communication device 212 and the memory device 216. The processing device 214 uses the communication device 212 to communicate with the network 201 and other devices on the network 201, such as, but not limited to the ATM 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 open a financial institution account, remotely communicate with an ATM to complete an ATM transaction, or authorize an ATM transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 2, the position adaptive ATM system environment 200 may contain numerous customer systems 204.

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the ATM 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the position adaptive ATM, but not limited to data created and/or used by the financial institution application 258.

In the embodiment illustrated in FIG. 2 and described throughout much of this specification, the financial institution application 258 authorizes an ATM transaction using the ATM 206, receives sensor data, determines an appropriate adjustment to the ATM display and/or the information associated with the display, and communicates the adjustment to the ATM 206.

In some embodiments, the financial institution application 258 may authorize an ATM transaction between a customer 202 and a financial institution. In this way, the customer 202 may provide an authentication to the ATM 206 via his/her customer system 204, by swiping a ATM or debit card, providing a PIN number, contactless communication, or the like. The financial institution application 258 may identify the customer 202 based on the authentication and allow the customer 202 to proceed and complete an ATM transaction.

In some embodiments, the financial institution application 258 may receive sensor data from the ATM 206. The ATM 206 may have sensors associated with the ATM 206. In this way, customer and environmental characteristics may be identified. The ATM 206 may compile these characteristics and providing them to the financial institution application 258 as sensor data through the network 201.

In some embodiments, financial institution application 258 may determine an appropriate adjustment to the ATM display. Determining the appropriate adjustment to the ATM display includes determining an appropriate ATM display position based on the customer sensor data that maximized the customer's privacy during the ATM transaction. The determination is done by the financial institution application 258, utilizing all of the retrieved customer sensor data and compiling it together to determine an appropriate position for the ATM display and data presented on the ATM display for maximum privacy for the customer 202. As such, each customer sensor data, both customer related and environmentally related, as well as general information about the ATM 206 location may be taken into consideration by the financial institution application 258 and processed via the processing device 248.

In some embodiments, the financial institution application 258 may determine that the ATM display and information displayed thereon will be presented directly in front of the customer 202 and/or in front of the portion of the customer 202 that is least visible by others around the customer 202. In other embodiments, the financial institution application 258 may determine that other locations of the ATM display and/or the information displayed on the display may be displayed. In this way, the financial institution application 258 may provide a display that is least visible to others around the customer 202. Thus, the financial institution application 258 may determine that the ATM display may need to be in the left, right, center, lower left, lower right, lower center, upper right, upper left and/or upper center of the ATM 206. Furthermore, the financial institution application 258 may determine that the information within the display may be presented in the entire display, a portion of the display, or the like. The financial institution application 258 takes into consideration all received customer sensor data to provide a secure and private position of an ATM display and the information presented thereon within the ATM 206. Furthermore, if one or more locations are determined to be private, the financial institution application 258 may select the position that the financial institution application 258 determines to be the most comfortable viewing area for the customer 202 based on the time of day, customer stature, eye location, and/or the like. As such, the system provides the most private, yet comfortable viewing area for ATM transaction information to be presented to a user on an ATM 206.

In some embodiments, the financial institution application 258 determines the appropriate ATM display location and location of the information presented thereon based on finding the most private location on the ATM 206 for the customer 202. This may be the portion of the ATM 206 most restricted from the public around the customer 202 based on the customer's position, time of day, ATM 206 location, and the like. Furthermore, the financial institution application 258 utilizes the customer sensor data and general information about the location of the ATM 206 to determine the most private location for presentation of the ATM display and the information presented on the ATM display for the customer 202 to complete the ATM transaction.

Once the financial institution application 258 determines the appropriate location for the ATM display and presentation of information on the display, the financial institution application 258 may communicate that location to the ATM 206 via the network 201.

As illustrated in FIG. 2, the ATM 206 is connected to the financial institution server 208 and provides customer 202 interaction. The ATM 206 generally comprises a reading device 235, a communication device 236, a processing device 238, and a memory device 240. The reading device 235 is operatively coupled to the processing device 238, communication device 236, and the memory device 240. The ATM 206 may include a reader device 235 to receive authentication of customer 202 access to his/her accounts at the financial institution. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment account and/or transaction data at the ATM 206 and communicates the information via the communication device 236 over a network 201, to other systems such as, but not limited to the financial institution server 208 and/or the customer system 204. As such, the communication device 236 generally comprises a modem, server, or other device for communicating with other devices on the network 201.

As further illustrated in FIG. 2, the ATM 206 comprises computer-readable instructions 242 stored in the memory device 240, which in one embodiment includes the computer-readable instructions 242 of an ATM application 244.

In the embodiment illustrated in FIG. 2, the ATM application 244 identifies a customer 202 at the ATM 206, senses customer 202 and environment characteristics, provides sensor data to the financial institution server 208, and adjusts the ATM display and/or the ATM information presented on the display.

In some embodiments, the ATM application 244 may identify a customer 202 when he/she initiates or approaches an ATM for an ATM transaction. In some embodiments the ATM application 244 may identify a customer 202 by customer authorization at the reader device 235. In some embodiments, the ATM application 244 may identify the customer 202 based on associate or customer 202 input. In yet other embodiments, the ATM application 244 may identify the customer 202 as being a pre-determined distance away from the ATM 206.

In some embodiments, the ATM application 244 senses customer 202 and environment characteristics using sensors associated with the ATM 206. The sensing of customer 202 and environmental characteristics is preformed via one or more sensors associated with the ATM 206. These one or more sensors collect sensor data from the characteristics identified and are collected and compiled by the ATM application 244. The sensor can identify and track data associated with the customer and/or the environment. The sensors may include motion sensors, distance sensors, temperature sensors, video cameras, eye tracking sensors, or the like. These sensors may be optical, passive infrared (PIR), microwave, ultrasonic, tomographic motion detector, video camera software, heat detector, motion controllers, motion detectors, remote cameras, acoustic sensors, or the like.

In some embodiments, the ATM application 244 collects data from sensors that track customer 202 characteristics. In some embodiments, the ATM application 244 collects data from sensors that track environmental data. Customer data may include the identification of the customer's location relative to the ATM 206. In this way, the system may utilize sensors, such as motion sensors or the like that identify a distance the customer is from a known point on the ATM 206. The ATM application 244 through sensors may identify the horizontal location of the customer 202. In some embodiments, the ATM application 244 through sensors may identify the vertical location of the customer 202 relative to the ATM 206. In some embodiments, the ATM application 244 through sensors may also identify the distance the customer 202 is from the ATM 206. In this way, the sensor may include sensing capabilities such as optical, passive infrared (PIR), microwave, ultrasonic, tomographic motion detector, video camera software, heat detector, motion controllers, motion detectors, remote cameras, acoustic sensors, or the like may be able to identify the customer 202 and his/her location relative to the ATM 206.

In some embodiments the ATM application 244 may sense environmental characteristics using sensors associated with the ATM 206 and/or pre-determined information about the location of the ATM 206 relative to public locations. In this way, the ATM application 244 may gather information associated with the time of day, temperature, location, and the like associated with the environment around the ATM 206.

In some embodiments, the ATM application 244 provides sensor data to the financial institution server 208. The communication is directed from the ATM application 244 through the network 201 to the financial institution server 208.

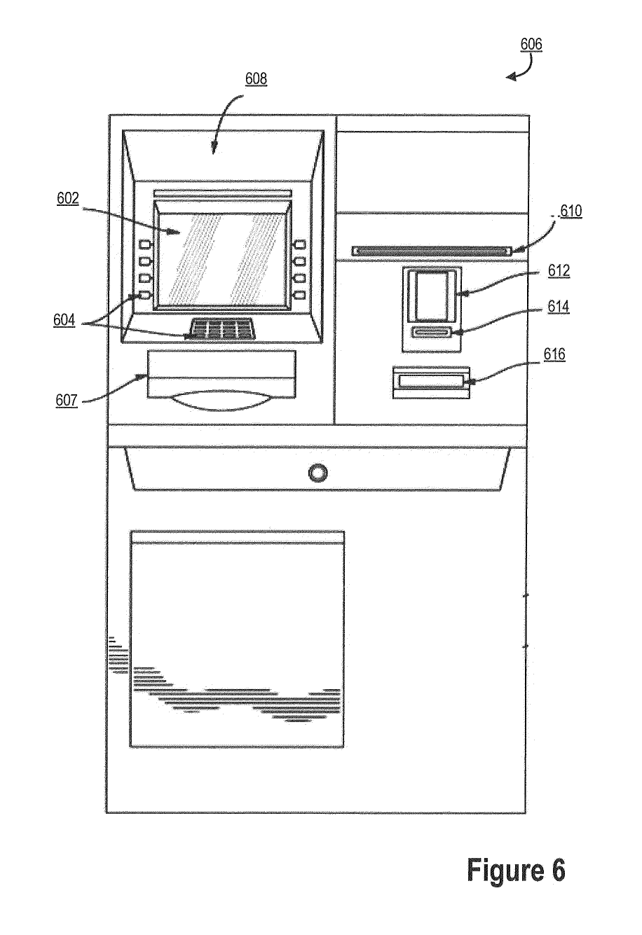

In some embodiments the ATM application 244 adjusts the ATM display and/or the ATM information presented on the display. In this way, upon receiving the determined location from the financial institution server 208, the ATM application 244 may mechanically move the ATM display location to one or more different locations on the ATM 206. In this way the ATM application 244 may mechanically adjust the ATM display and/or the other devices associated with the ATM 206, as further illustrated in FIG. 6. Mechanical adjustments include vertical/horizontal adjustments of the display, tilt adjustments of the display, vertical/horizontal adjustments of other ATM associated devices, and/or tilt adjustment of other ATM associated devices. Vertical/horizontal adjustment of the display and other devices may be performed by the ATM application 244 utilizing a track movement mechanism, pulley system, or the like that moves the display about the ATM to various locations. Tilt adjustment of the display may be performed by the ATM application 244 and allows for automatic tilting of the display left, right, up, or down in order to provide privacy and comfortable viewing to the customer. The tilt adjustment may be performed using a ball-and-socket or other type of tilt adjustment, such as telescoping or the like.

In some embodiments, the ATM application 244 may provide software adjustment of the ATM information presented on the ATM display of the ATM 206 for the customer's ATM transaction. In this way, the information and data presented to the customer 202 while he/she is performing an ATM transaction may be adjusted within the ATM display to provide additional privacy and comfort for viewing. The ATM application 244 may adjust the location of the presentation of ATM information on the ATM display. In some embodiments, the information may be presented on the entire ATM display. In other embodiments, the information may be presented on one or more smaller portions of the ATM display. The ATM application 244 system may provide a software adjustment to the information on the ATM display by adjusting the brightness level of the information on the display. In some embodiments, the ATM application 244 may turn the ATM display off completely when it is identified that the customer is not looking at the ATM display screen. In other embodiments, the adjustment of brightness level of information on the display may be dimmed or brightened for the privacy of the customer 202.

It is understood that the servers, systems, and devices described herein illustrate one embodiment of the invention. It is further understood that one or more of the servers, systems, and devices can be combined in other embodiments and still function in the same or similar way as the embodiments described herein.

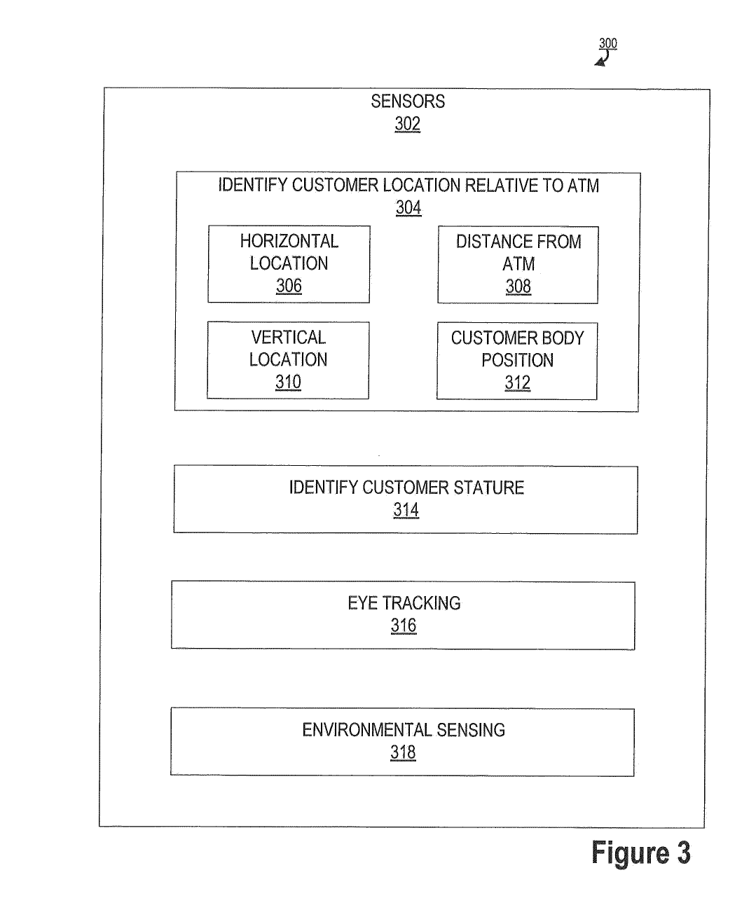

FIG. 3 illustrates a process map for sensing of customer positioning 300, in accordance with one embodiment of the present invention. The sensing of customer characteristics is preformed via one or more sensors associated with the ATM. These one or more sensors 302 collect sensor data from the characteristics identified to be compiled to determine ATM display adjustment to maximize privacy of a customer in a public location of an ATM. The sensor can identify and track data associated with the customer and/or the environment. The sensors may include motion sensors, distance sensors, temperature sensors, video cameras, eye tracking sensors, or the like. These sensors may be optical, passive infrared (PIR), microwave, ultrasonic, tomographic motion detector, video camera software, heat detector, motion controllers, motion detectors, remote cameras, acoustic sensors, or the like.

In some embodiments, the sensors 302 track data associated with the customer. In some embodiments, the sensors 302 track data associated with the environment. Customer data may include the identification of the customer's location relative to the ATM 304. In this way, the system may utilize sensors, such as motion sensors or the like that identify a distance the customer is from a known point on the ATM. The sensors 302 may identify the horizontal location of the customer 306. The horizontal location of the customer 306 includes the horizontal location of the customer relative to the center of the ATM. In this way, a customer may be leaning more to the left of the ATM or the right of the ATM. Furthermore, the sensor may determine if the customer covers a portion of the ATM, the entire display of the ATM, or the like. As such, this data may determine the amount of exposure of the ATM to the public depending on the horizontal positioning of the customer in front of or to the side of the ATM. In some embodiments, the sensors 302 may identify the vertical location of the customer 310. As such, the customer may be positioned over the top of the ATM or squatting below the ATM display. In this way, the sensors 302 identify the vertical location 310 of the customer relative to the ATM display screen. In some embodiments, the sensors 302 may also identify the distance the customer is from the ATM 308. As such, the system may identify if the customer is close to the ATM or several feet away from the ATM. Finally, the sensors 302 may identify the customer body position 312 relative to the ATM. In this way, the sensors 302, via optical, passive infrared (PIR), microwave, ultrasonic, tomographic motion detector, video camera software, heat detector, motion controllers, motion detectors, remote cameras, acoustic sensors, or the like may be able to identify the general body position of the customer in front of the ATM. As such, incorporating the horizontal location 306, vertical location 310, distance from the ATM 308, and the customer body position 312 the system may determine an exact position of the customer in relationship to the ATM. As such, the system may be able to utilize this information and other sensor information to determine an appropriate position to position the ATM display and information on the display to maximize customer privacy.

As further illustrated in FIG. 3, the sensors 302 may also identify customer data such as the customer's stature 314. As such, the system may utilize data associated with the customer's stature to determine how much of the display screen the customer may be blocking from the view of public passer-byes. This way, the system may adjust the ATM display to limit the visibility of others from viewing the ATM display and the information being presented thereon.

In some embodiments, the sensors 302 may also perform eye tracking of the customer, as illustrated in block 314. In this way, the sensor may be programmed to identify and monitor the eye location of the customer, such that the system may track where the customer is looking. In this way, the system can trigger a response to the customer based on his/her location of visualization. For example, if the customer is in the middle of an ATM transaction and the sensor 302 identifies that he/she looks away from the ATM display, such as behind him/her, the system may dim or turn off the display so that the customer's private information remains that way. Furthermore, the eye tracking sensor 316 may also provide the system with an indication of a comfortable viewing area for the ATM display for that particular customer. As such, if the comfortable viewing area is in a determined private location, the system will present the ATM transaction data in that area.

Finally, as illustrated in FIG. 3, the sensors 302 may also provide for environmental sensing, as illustrated in block 318. Sensors 302 for environmental sensing 318, include sensors that are capable of sensing the time of day, shadowing, temperature, precipitation conditions, popularity of ATM location, or the like associated with the environment surrounding the ATM.

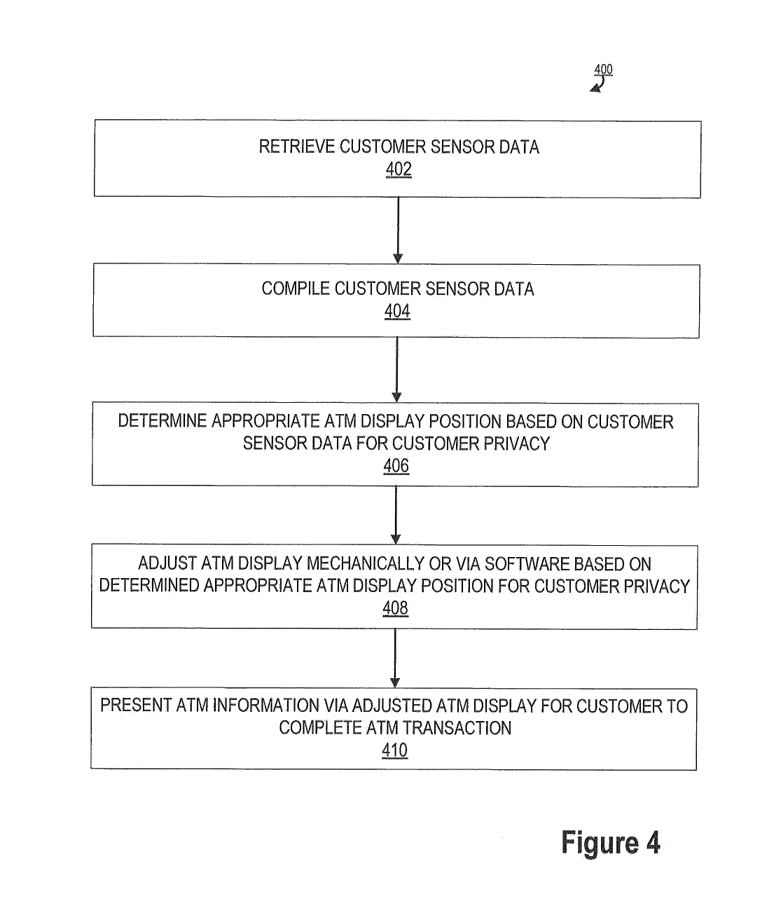

FIG. 4 illustrates a process map for determining a positioning of ATM data for an ATM transaction 400, in accordance with one embodiment of the present invention. The process 400 is initiated when the system retrieves the customer sensor data captured by the one or more sensors, as illustrated in block 402. This data is retrieved from the sensed characteristics determined by the one or more sensors. Next, as illustrated in block 404, the process 400 continues by compiling the customer sensor data that was retrieved in block 402.

Once compiled, the system may determine an appropriate ATM display position based on the customer sensor data that maximized the customer's privacy during the ATM transaction, as illustrated in block 406. The determination is done by utilizing all of the retrieved customer sensor data and compiling it together to determine an appropriate position for the ATM display and data presented on the ATM display for maximum privacy for the customer. As such, each customer sensor data, both customer related and environmentally related, as well as general information about the ATM location may be taken into consideration. General information about the ATM may include the ATMs location and general popularity of the particular location.

In some embodiments, the ATM display and information displayed thereon will be presented directly in front of the customer and/or in front of the portion of the customer that is least visible by others around the customer. Providing a display that is least visible to others around the customer may indicate that the ATM display may need to be in the left, right, center, lower left, lower right, lower center, upper right, upper left and/or upper center of the ATM. Furthermore, the information within the display may be presented in the entire display, a portion of the display, or the like. The system takes into consideration all received customer sensor data to provide a secure and private position of an ATM display and the information presented thereon. Furthermore, if one or more locations are determined to be private, the system may select the position that the system determines to be the most comfortable viewing area for the customer based on the time of day, customer stature, eye location, and/or the like. As such, the system provides the most private, yet comfortable viewing area for ATM transaction information to be presented to a user on an ATM.

In some embodiments, the determined appropriate ATM display location is based on the determined most private location on the ATM for the display. The private location is determined based on the customer sensor data and general information about the location of the ATM. For example, if an ATM is located on an elevated platform, the system may recognize that lower regions may be more visible to the public. Furthermore, if the ATM is located on a busy street, the system may determine that maximum privacy may be needed. In this way, the display of the ATM and/or the information displayed thereon may be positioned in the area of the ATM that is most private based on where the customer is positioned in front of the ATM and where others may be able to view on the ATM when the customer is in front of the ATM.

Next, as illustrated in block 408, once a determination is made for the appropriate ATM display position and the appropriate position of the information to be presented on the display in block 406, the process 400 continues by adjusting the ATM display mechanically or via software based on the determined appropriate ATM display position for the customer and his/her privacy. Finally, as illustrated in block 410, the ATM information may be presented to the customer via the adjusted ATM display for the customer to complete the ATM transaction.

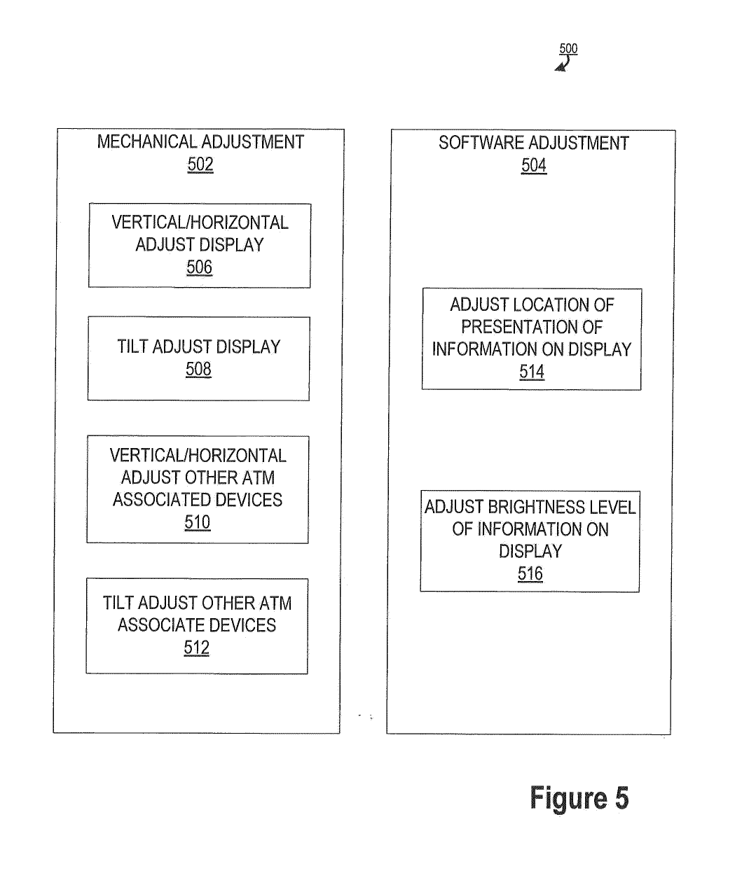

FIG. 5 illustrates a process map for the mechanical and software adjustment of the ATM display and ATM information presented on the display 500, in accordance with one embodiment of the present invention. In some embodiments, the ATM display may be adjusted using a mechanical adjustment 502. In some embodiments, the location of the information presented on the ATM display may be adjusted using a software adjustment 504.

Mechanical adjustments 502 include vertical/horizontal adjustments of the display 506, tilt adjustments of the display 508, vertical/horizontal adjustments of other ATM associated devices 510, and/or tilt adjustment of other ATM associated devices 512. Vertical/horizontal adjustment of the display 506 may be performed by utilizing a track movement mechanism, pulley system, or the like that moves the display about the ATM to various locations. In some embodiments, the vertical/horizontal adjustment of the display 506 may be performed electronically by the system based on the customer sensor data. The vertical/horizontal adjustment of the display 506 may provide adjustments to the ATM display vertically, horizontally, or on any angle required to provide privacy to the customer. Tilt adjustment of the display 508 allows for automatic tilting of the display left, right, up, or down in order to provide privacy and comfortable viewing to the customer. The tilt adjustment may be performed using a ball-and-socket or other type of tilt adjustment, such as telescoping or the like. Similarly to above the other ATM associated devices may vertically/horizontally adjust 510 and the other ATM associated devices may tilt adjust 512. The other ATM associated devices may include one or more of the debit/credit card input, withdraw slot, deposit slot, key pad, or the like.

In some embodiments, the system may provide software adjustment 504 of the ATM information presented on the ATM display for the customer's ATM transaction. In this way, the information and data presented to the customer while he/she is performing an ATM transaction may be adjusted within the ATM display to provide additional privacy and comfort for viewing. As illustrated in block 514, the system may adjust the location of the presentation of ATM information on the ATM display. In some embodiments, the information may be presented on the entire ATM display. In other embodiments, the information may be presented on one or more smaller portions of the ATM display. As illustrated in block 516, the system may provide a software adjustment 504 to the information on the ATM display by adjusting the brightness level of the information on the display. In some embodiments, the system may turn the ATM display off completely when it is identified that the customer is not looking at the ATM display screen. In other embodiments, the adjustment of brightness level of information on the display 516 may be dimmed or brightened for the privacy of the customer.

FIG. 6 provides a representative illustration of an ATM 606, in accordance with one embodiment of the present invention. In some embodiments, the representative ATM may comprise features similar to features found on a standard ATM. The lighting means 608 may be located above the display 602 that may provide a customer light for use during an ATM transaction. Of note, the display 602 may be vertically adjusted or horizontally adjusted along tracks or the like to position itself across the entire ATM 606. While currently illustrated in the upper left corner of the ATM 606, one will appreciate that the display may move to the right upper corner or below to the lower corners of the ATM 606 and/or anywhere in between if necessary. The lighting means 608 may also be moved with the ATM display 602 and provide the customer a safety mechanism to aid in the ATM transaction.

The cash receptacle 607 may provide the customer means for receiving cash that the customer requests for a withdraw through the ATM transaction. In some embodiments, the ATM 606 may also include a contactless identification sensor 612, a contact identification sensor 614 such as a debit or ATM card acceptor, a keypad 604, a receipt receptacle 610, and a deposit receptacle 616. In some embodiments, the contactless identifier 612 and/or the contact identifier 614 may provide the ATM 606 means of receiving identification from the customer. The customer may provide contactless or contact identification means through the ATM 606. The identification means using the contactless or contact identifications may be provided through several mechanisms, including, but not limited to, biometric identification, laser identification, magnetic strip identification, barcode identification, radio frequency (RF), a character recognition device, a magnetic ink, code readers, wireless communication, debit card scanning, ATM card scanning, and/or the like. The authentication from the contactless identifier of contact identifier may be read by the ATM application. After the authentication has been read, the system may provide the authentication to the financial institution to authorize an ATM transaction.

In some embodiments, the keypad 604 may provide for identification of the customer for use of the ATM 606. The keypad 604 may provide the customer means for inputting a pin number identification. In this way, the keypad 604 enables the customer to input his pin number into the ATM 606. In some embodiments, the pin number inputted on the keypad 604 may be read by the system. After the pin number has been read, the ATM 606 may receive the pin number and provide authentication of the identification with the financial institution system.

The display 602 provides a means for displaying information related to the customer's ATM transaction. Display information may be, but is not limited to display of interfaces, such as the start-up interface and an ATM transaction interface. In some embodiments, the display 402 is a touch screen display module.

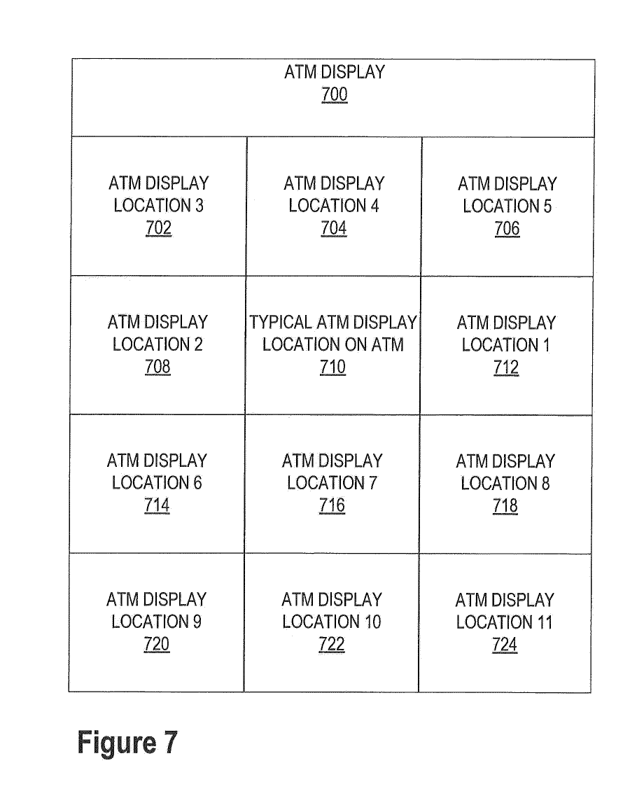

FIG. 7 illustrates a process map presenting the software adjustment of the ATM display 700, in accordance with one embodiment of the present invention. As illustrated in FIG. 7, the ATM display 700 is illustrated. In this embodiment, there are 12 different locations or quadrants within the ATM display 700 that the ATM information may be presented to the customer for viewing and completing an ATM transaction. As such, the system may present the ATM information on the display in one or more of the various quadrants such that the customer may be presented with the ATM information in the most private location on the ATM display 700. In the embodiment illustrated in FIG. 7 the ATM display 700 includes several display locations, including a typical Display Location 710, Display Location 1 712, Display Location 2 708, Display Location 3 702, Display Location 4 704, Display Location 5 706, Display Location 6 714, Display Location 7 716, Display Location 8 718, Display Location 9 720, Display Location 10 722, Display Location 11 724.

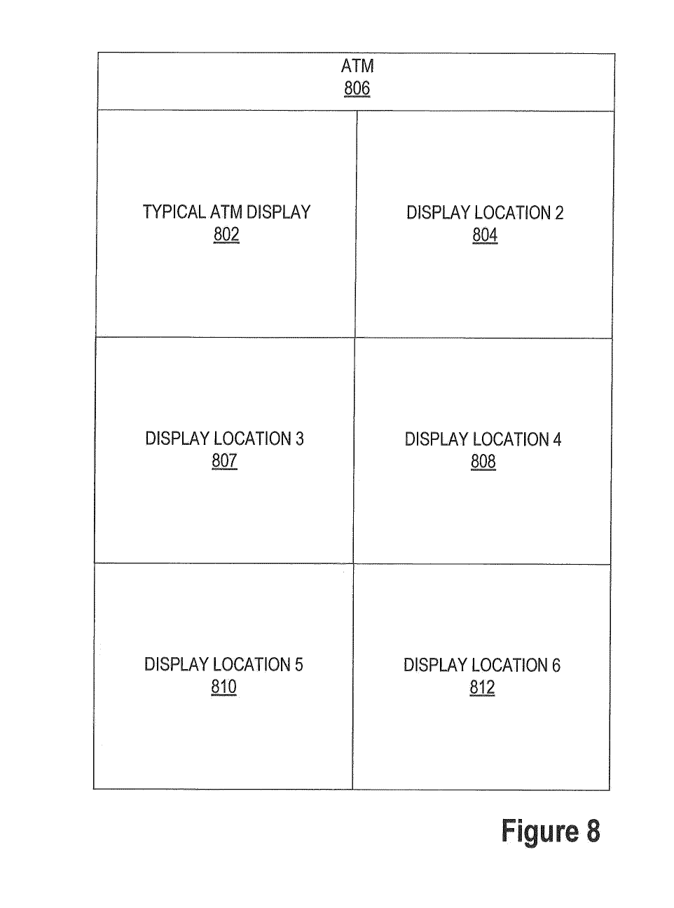

FIG. 8 illustrates a process map of the mechanical adjustment of ATM display on the ATM 806, in accordance with one embodiment of the present invention. As such, the system may mechanically move the ATM display and/or other components of the ATM 806 to various locations within the ATM 806 for privacy purposes. In the embodiment illustrated in FIG. 8, the typical ATM display may be presented on a location on the ATM 802. However, alternative locations of the ATM display may be provided. The ATM display may be mechanically moved and relocated to each of the one or more other locations. These locations include ATM Display Location 2 804, ATM Display Location 3 807, ATM Display Location 4 808, ATM Display Location 5 810, and ATM Display Location 6 812.

What is claimed is:

1. A system for a position adaptive automated teller machine (ATM), the system comprising:
a memory device with computer-readable program code stored thereon;
a communication device;
a processing device operatively coupled to the memory device and the communication device, wherein the processing device is configured to execute the computer-readable program code to:
identify a customer initiating a transaction at the ATM;
sense, via sensors associated with the ATM, an environment surrounding the ATM and customer characteristics associated with the customer initiating the transaction at the ATM;
determine, based on the customer characteristics and environmental surroundings, an appropriate location on the ATM for an ATM display to present information to the customer to complete an ATM transaction, wherein the appropriate location is determined to provide privacy to the customer and prevent other individuals from viewing the ATM display;
determine, based on the customer characteristics and environmental surroundings, an appropriate location on the ATM display for presentation of information to the customer to complete an ATM transaction, wherein the appropriate location is determined to provide privacy to the customer and prevent other individuals from viewing the ATM display;
adjust, mechanically, a location of the ATM display to the appropriate location based on the determined appropriate location on the ATM for the ATM display;
adjust a location of the presentation of information to the customer to the appropriate location based on the determined appropriate location on the ATM display for presentation of information to the customer to complete an ATM transaction; and
present the ATM display with the presentation of information for the customer to complete the ATM transaction.

2. The system of claim 1 further comprising tracking the eyes of the customer using the sensors, wherein when the sensors identify the customer's eyes no longer focused on the ATM, the ATM display is dimmed.

3. The system of claim 1, wherein mechanically adjusting the location of the ATM display comprises moving the ATM display on a track system to one or more locations on the ATM.

4. The system of claim 1, wherein mechanically adjusting the location of the ATM display comprises tilting the ATM display on the ATM.

5. The system of claim 1, wherein adjusting the location of the presentation of information comprises moving the information to one or more locations on the ATM display.

6. The system of claim 1, wherein adjusting the location of the presentation of information comprises adjusting the brightness level of the presentation of information on the ATM display.

7. The system of claim 1 further comprises determining a comfortable viewing location of the ATM display for the customer based on customer characteristics sensed and adjusting the ATM display to the comfortable viewing location, wherein the comfortable viewing location is determined to provide privacy to the customer and prevent other individuals from viewing the ATM display.

8. The system of claim 1, wherein the sensors associated with the ATM identify the environmental surroundings of the ATM including a time of day, shadowing, temperature, precipitation conditions, and population surrounding the ATM.

9. The system of claim 1, wherein the sensors associated with the ATM identify the customer characteristics including the horizontal/vertical location of the customer, the distance the customer is from the ATM, the body position of the customer, and the stature of the customer relative to the ATM.

10. A computer program product for a position adaptive automated teller machine (ATM), the computer program product comprising at least one non-transitory computer-readable medium having computer-readable program code portions embodied therein, the computer-readable program code portions comprising:
an executable portion configured for identifying a customer initiating a transaction at the ATM;
an executable portion configured for sensing, via sensors associated with the ATM, an environment surrounding the ATM and customer characteristics associated with the customer initiating the transaction at the ATM, wherein the environment around the ATM comprises a location of the ATM and traffic around the ATM, and wherein customer characteristics include a relative vertical and horizontal location of the customer relative to the ATM;
an executable portion configured for determining, based on the customer characteristics and environmental surroundings, an appropriate location on the ATM for an ATM display to present information to the customer to complete an ATM transaction, wherein the appropriate location is determined to provide privacy to the customer and prevent other individuals from viewing the ATM display;
an executable portion configured for determining, based on the customer characteristics and environmental surroundings, an appropriate location on the ATM display for presentation of information to the customer to complete an ATM transaction, wherein the appropriate location is determined to provide privacy to the customer and prevent other individuals from viewing the ATM display;
an executable portion configured for adjusting, mechanically, a location of the ATM display to the appropriate location based on the determined appropriate location on the ATM for the ATM display;
an executable portion configured for adjusting a location of the presentation of information to the customer to the appropriate location based on the determined appropriate location on the ATM display for presentation of information to the customer to complete an ATM transaction; and
an executable portion configured for presenting the ATM display with the presentation of information for the customer to complete the ATM transaction.

11. The computer program product of claim 10 further comprising an executable portion configured for tracking the eyes of the customer using the sensors, wherein when the sensors identify the customer's eyes no longer focused on the ATM, the ATM display is dimmed.

12. The computer program product of claim 10, wherein mechanically adjusting the location of the ATM display comprises moving the ATM display on a track system to one or more locations on the ATM or tilting the ATM display on the ATM.

13. The computer program product of claim 10, wherein adjusting the location of the presentation of information comprises moving the information to one or more locations on the ATM display or adjusting the brightness level of the presentation of information on the ATM display.

14. The computer program product of claim 10 further comprises an executable portion configured for determining a comfortable viewing location of the ATM display for the customer based on customer characteristics sensed and adjusting the ATM display to the comfortable viewing location, wherein the comfortable viewing location is determined to provide privacy to the customer and prevent other individuals from viewing the ATM display.

15. The computer program product of claim 10, wherein the sensors associated with the ATM identify the customer characteristics including the horizontal/vertical location of the customer, the distance the customer is from the ATM, the body position of the customer, and the stature of the customer relative to the ATM.

16. A computer-implemented method for a position adaptive automated teller machine (ATM), the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a customer initiating a transaction at the ATM;
sensing, via sensors associated with the ATM, an environment surrounding the ATM and customer characteristics associated with the customer initiating the transaction at the ATM, wherein the environment around the ATM comprises a location of the ATM and traffic around the ATM, and wherein customer characteristics include a relative vertical and horizontal location of the customer relative to the ATM;
determining, by a computer device processor, based on the customer characteristics and environmental surroundings, an appropriate location on the ATM for an ATM display to present information to the customer to complete an ATM transaction, wherein the appropriate location is determined to provide privacy to the customer and prevent other individuals from viewing the ATM display;
determining, by a computer device processor, based on the customer characteristics and environmental surroundings, an appropriate location on the ATM display for presentation of information to the customer to complete an ATM transaction, wherein the appropriate location is determined to provide privacy to the customer and prevent other individuals from viewing the ATM display;
adjusting, mechanically, a location of the ATM display to the appropriate location based on the determined appropriate location on the ATM for the ATM display;
adjusting a location of the presentation of information to the customer to the appropriate location based on the determined appropriate location on the ATM display for presentation of information to the customer to complete an ATM transaction; and
presenting the ATM display with the presentation of information for the customer to complete the ATM transaction.

17. The computer-implemented method of claim 16 further comprising an executable portion configured for tracking the eyes of the customer using the sensors, wherein when the sensors identify the customer's eyes no longer focused on the ATM, the ATM display is dimmed.

18. The computer-implemented method of claim 16, wherein mechanically adjusting the location of the ATM display comprises moving the ATM display on a track system to one or more locations on the ATM or tilting the ATM display on the ATM.

19. The computer-implemented method of claim 16, wherein adjusting the location of the presentation of information comprises moving the information to one or more locations on the ATM display or adjusting the brightness level of the presentation of information on the ATM display.

20. The computer-implemented method of claim 16 further comprises an executable portion configured for determining a comfortable viewing location of the ATM display for the customer based on customer characteristics sensed and adjusting the ATM display to the comfortable viewing location, wherein the comfortable viewing location is determined to provide privacy to the customer and prevent other individuals from viewing the ATM display.
